(19) United States
(12) Patent Application Publication
(10) Pub. No.: US 2023/0291234 A1
(43) Pub. Date: Sep. 14, 2023

(54) WIRELESS CHARGING STAND

(71) Applicant: Libratel Inc., Toronto (CA)

(72) Inventor: Peter Pejouyan, Toronto (CA)

(21) Appl. No.: 18/119,700

(22) Filed: Mar. 9, 2023

Related U.S. Application Data
(60) Provisional application No. 63/318,129, filed on Mar. 9, 2022.

(51) Int. Cl. H02J 50/00; H02J 50/10

(52) U.S. Cl. CPC H02J 50/005; H02J 50/10

(57) ABSTRACT

A wireless charging stand for a mobile device, including a foldable frame with a base panel extending generally in a first plane and an upper panel extending generally in a second plane. The base panel and the upper panel are connected by a hinge such that the base panel and the upper panel can be folded flat with the upper panel against and overlying the base panel and the first and second planes generally parallel. The upper panel also includes a wireless charger and a magnetic mounting system. The stand includes a suction cup secured to a lower surface of the base panel to releasably mount the wireless charging stand to an environmental surface.

### FIELD

The specification relates generally to wireless charging of mobile devices, and more specifically to wireless charging stands for mobile devices.

### BACKGROUND

U.S. Pat. No. 9,913,388 to Mchatet (“Mchatet”) purports to disclose a universal magnetic mounting assembly having a case assembly with a hole that has a first circumference, and a rear wall, first and second lateral walls, and top and bottom walls. Mchatet purports to disclose that the rear wall has interior and exterior faces, and the case assembly cradles an electronic device. Mchatet purports to disclose a magnet that has an interior wall, a perimeter edge having a second circumference, an exterior wall, an angled wall, and an interior edge. Mchatet purports to disclose that the angled wall is concavely shaped and extends from the exterior wall to the interior edge, the magnet protrudes through the hole, whereby the first circumference is larger than the second circumference. Mchatet purports to disclose a cover plate that has a third circumference larger than the first circumference and is ferromagnetic and/or metallic. Mchatet purports to disclose that the cover plate is positioned between the electronic device and the interior face of the rear wall. Mchatet purports to disclose further having a mounting device with a base and a spherically shaped metallic surface.

U.S. Pat. App. No. 20170086314 to Simon (“Simon”) purports to disclose an adjustable support for holding an electronic device having a display at a desired elevated position for viewing of the display without tilting of the user’s head. Simon purports to disclose that the support includes an upright elongated member pivotally connected to a generally planar base piece held beneath the user’s thigh so as to hold the pivotally connected elongated member in an upright position. Simon purports to disclose that a telescoping and gooseneck segment enhance the adjustability of the position of the upright member at level and orientation enabling easy viewing of the display without tipping the head of a seated or reclining user. Simon purports to disclose that a magnetic or clamping cradle adjacent an upper end of the upright member by a ball joint engages the electronic device, with the ball joint providing adjustment of the orientation of the electronic device.

U.S. Pat. No. 10,261,543 to Schachter et al. (“Schachter”) purports to disclose a mobile device cradle with improved functionality. Schachter purports to disclose that such added functionality makes the mobile device cradle useful even when not coupled with a mobile device. Schachter purports to disclose that cradles with improved functionality will find use in vehicles, homes, offices, and the like.

### SUMMARY

The following summary is intended to introduce the reader to various aspects of the applicant’s teaching, but not to define any invention.

According to some aspects, there is provided a wireless charging stand for a mobile device, comprising a foldable frame having a top end and a bottom end, the foldable frame including a base panel extending generally in a first plane and an upper panel extending generally in a second plane, the base panel and the upper panel connected by a hinge such that the base panel and the upper panel can be folded with the upper panel against and overlying the base panel and the first and second planes generally parallel; a wireless charger included in the upper panel and arranged facing an upper surface of the upper panel to charge the mobile device when the mobile device is received against the upper surface of the upper panel; a magnetic mounting system included in the upper panel adjacent the wireless charger to hold the mobile device against the upper surface of the upper panel; and a suction cup secured to a lower surface of the base panel and directed away from the lower surface of the base panel to releasably mount the wireless charging stand to an environmental surface.

In some examples, the upper panel and the base panel are each generally planar panels, and the foldable frame folds flat with the upper panel against and overlying the base panel.

In some examples, the upper panel and the base panel each have a maximum length, a maximum width, and a maximum depth, and for each of the upper and base panels the maximum depth is less than about 25% of the lesser of the maximum width and the maximum length.

In some examples, the base panel has a consistent depth across generally the entire panel, the consistent depth equal to the maximum depth of the base panel.

In some examples, the upper panel and the base panel each include a metal plate.

In some examples, the upper panel and the base panel each include an aluminum plate.

In some examples, the suction cup includes a circular cup with a diameter between about 5 cm and about 10 cm.

In some examples, the diameter of the circular cup is between about 6 cm and about 7 cm.

In some examples, the circular cup is a transparent plastic cup.

In some examples, the suction cup is secured to the base panel via a threaded fastener and a washer, with the washer and a head of the threaded fastener positioned in an inner cup region of the suction cup.

In some examples, the length of the upper panel is greater than the length of the base panel such that an upper portion of the upper panel extends beyond the base panel when the upper panel is folded flat against and overlying the base panel, wherein the wireless charger includes a cord to supply power to the wireless charger, and wherein the cord extends out from a lower surface of the upper panel and from the upper portion of the upper panel.

In some examples, the hinge includes a first cylindrical portion having a first longitudinal axis, and the hinge includes a second cylindrical portion having a second longitudinal axis, and wherein the first and second cylindrical portions are arranged with the first and second longitudinal axes each coaxial with an axis of rotation of the hinge, and the first and second cylindrical portions are rotatable relative one another about the axis of rotation.

In some examples, when the frame is folded with the upper panel against and overlying the base panel, the axis of rotation is in an axis plane that is generally parallel to the first and second planes, and an inner edge of the base panel is joined to the first cylindrical portion below the axis plane, and an inner edge of the upper panel is joined to the second cylindrical portion above the axis plane and above the inner edge of the base panel.

In some examples, the hinge includes a track to limit the rotational movement of the first cylindrical portion relative to the second cylindrical portion.

In some examples, lateral edges of the upper panel are beveled and lateral edges of the base panel are beveled.

In some examples, the upper panel includes a protective pad on the upper surface around the wireless charger

In some examples, the upper panel includes a protective pad on a lower surface opposite the wireless charger and extending over the upper portion of the upper panel and the cord extends out from the protective pad on the lower surface of the upper panel.

According to some aspects, there is provided a method of using a wireless charging stand, comprising folding the wireless charging stand with an upper panel against a base panel, such that a suction cup and a wireless charger each face out from a foldable frame; and inserting the folded wireless charging stand into a pocket of an item of clothing.

According to some aspects, there is provided a mounting apparatus for retrofitting a mobile device or a mobile device case, comprising a continuous metal ring having a longitudinal axis, a circular inner diameter and a circular outer diameter and a generally constant depth between a rear face and a front face; and a layer of adhesive applied to the rear face.

According to some aspects, there is provided a magnetic adherence retrofit kit, comprising a wireless charging stand; and a mounting apparatus for retrofitting a mobile device or a mobile device case.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a perspective view of a mobile device stand bearing a mobile device;

FIG. 2 is an expanded side view of the mobile device stand of FIG. 1 bearing the mobile device;

FIG. 3 is a front view of the mobile device stand of FIG. 1 with the mobile device removed;

FIG. 4 is a perspective view of the mobile device stand of FIG. 1 with the mobile device removed;

FIG. 5 is a perspective view of the mobile device stand of FIG. 1 in a folded configuration;

FIG. 6 is a first expanded side view of the mobile device stand of FIG. 1 in the folded configuration;

FIG. 7 is a second side view of the mobile device stand of FIG. 1 in the folded configuration;

FIG. 8 is a third side view of the mobile device stand of FIG. 1 in the folded configuration;

FIG. 9 is bottom perspective view of the mobile device stand of FIG. 1;

FIG. 10 is a bottom view of the mobile device stand of FIG. 1; and,

FIG. 11 is a perspective view of a kit including the mobile device stand of FIG. 1.

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses or process described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors or owners do not intend to abandon, disclaim, or dedicate to the public any such invention by its disclosure in this document.

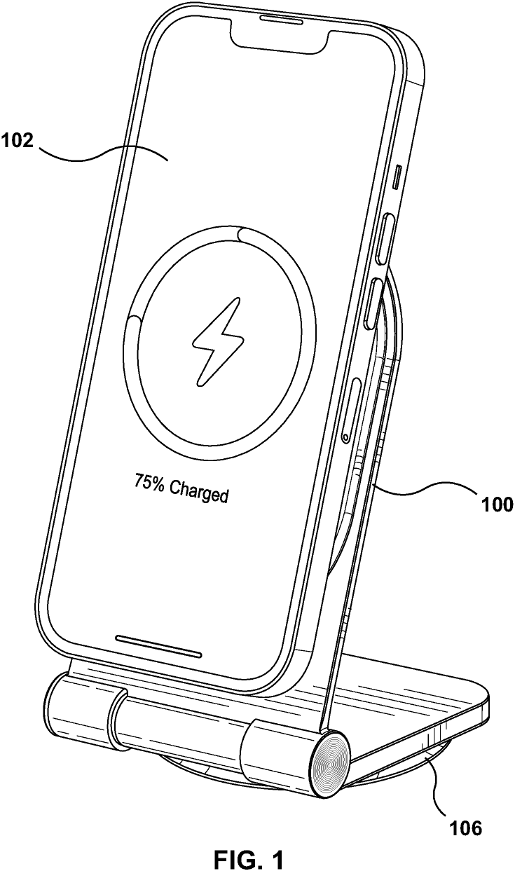

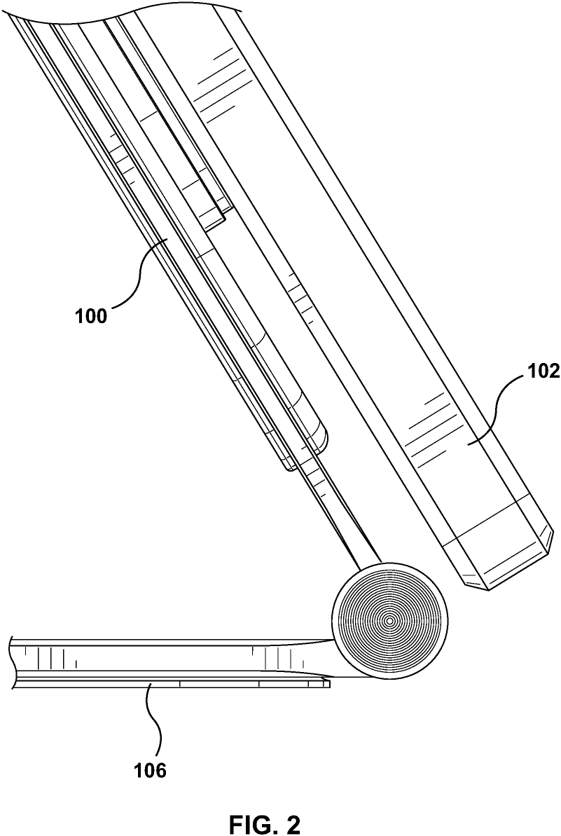

Referring to FIGS. 1 and 2, illustrated is an example of a wireless charging stand 100 for a mobile device 102. As exemplified, the mobile device 102 is a smartphone, such as an iPhone™. The mobile device 102 may be held against a portion of the stand 100 to be charged by a wireless charger of the stand 100, as described further elsewhere herein.

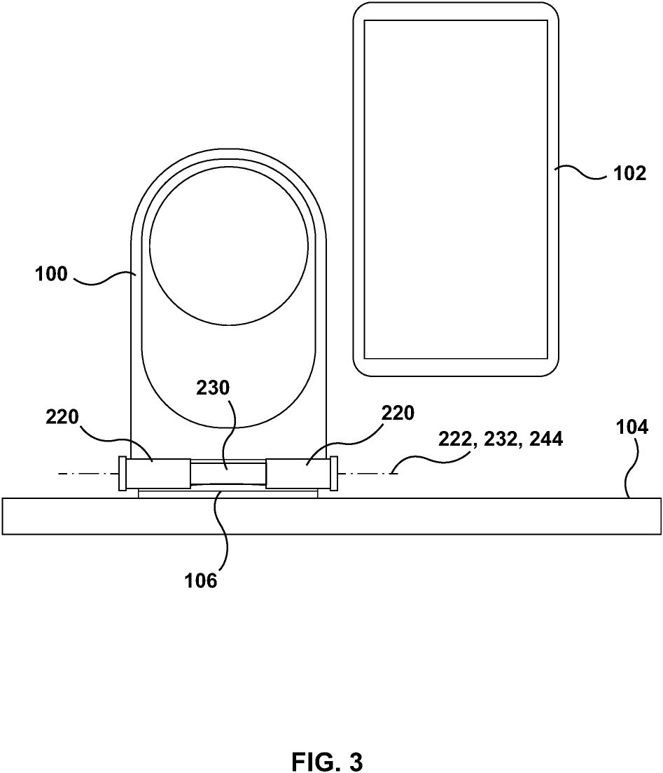

Referring now to FIG. 3, the mobile device 102 is removable from the stand 100. The stand 100 includes a stand magnetic mounting system that includes magnets and/or ferromagnetic material. The mobile device 102 includes a device magnetic mounting system that includes magnets and/or ferromagnetic material. For example, the mobile device 102 may be an iPhone™ with a MagSafe™ annular array of magnets.

As exemplified, the stand 100 is mounted to an environmental surface 104. The stand 100 is mounted to the environmental surface (e.g., a desk, counter, table, or window) such that when the mobile device 102 that is mounted to the stand 100 is lifted, the stand 100 does not come away with the mobile device 102. In other words, the stand 100 is mounted to the environmental surface 104 such that the mobile device 102 can be removed from the stand 100 easily. For example, a user may remove the mobile device 100 from the stand 100 using only one hand of the user (i.e., not needing to hold the stand 100 while lifting the mobile device 102).

The stand 100 is mounted to the environmental surface 104 via a suction cup 106. The suction cup 106 releasably secures the stand 100 to the environmental surface, as will hereinafter be described.

It will be understood that the mobile device 102 may optionally include a case over the main body of the mobile device 102, and the case may be between the main body and the stand 100.

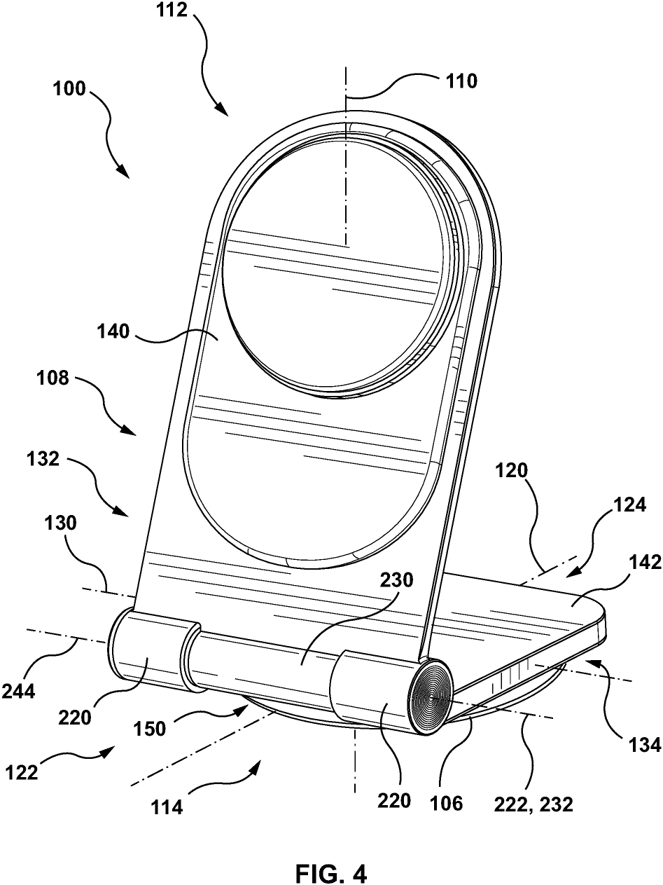

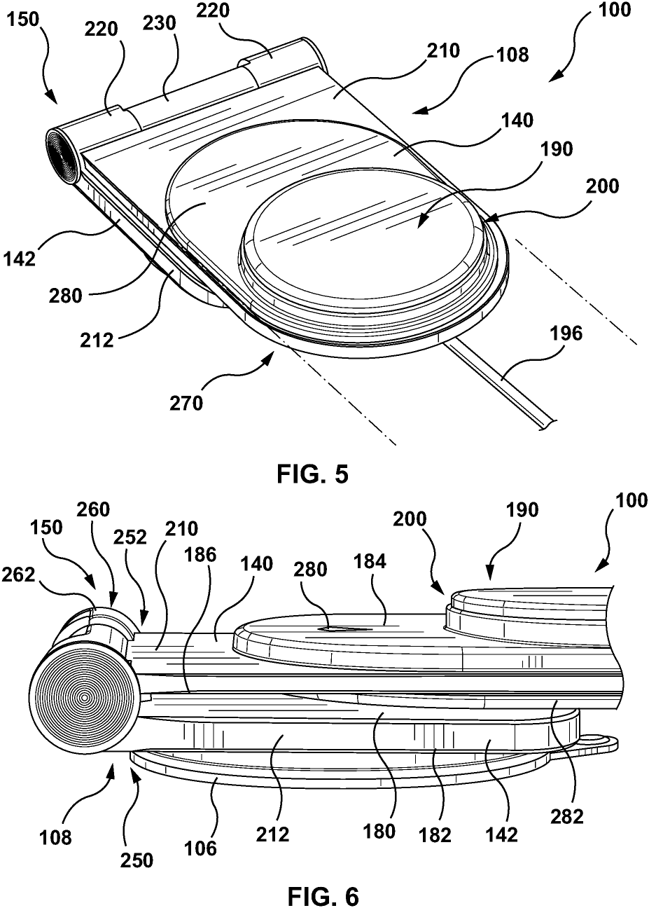

Referring now to FIG. 4, the wireless charging stand 100 includes a foldable frame 108. As exemplified in, e.g., FIG. 5, the frame 108 is configured to fold flat onto inself. Referring back to FIG. 4, the foldable frame 108 has a vertical axis 110 extending between a top end 112 and a bottom end 114. The foldable frame 108 has a stand longitudinal axis 120 extending between a front end 122 and a rear end 124. The foldable frame 108 also has a transverse axis 130 extending between a right lateral side 132 and a left lateral side 134.

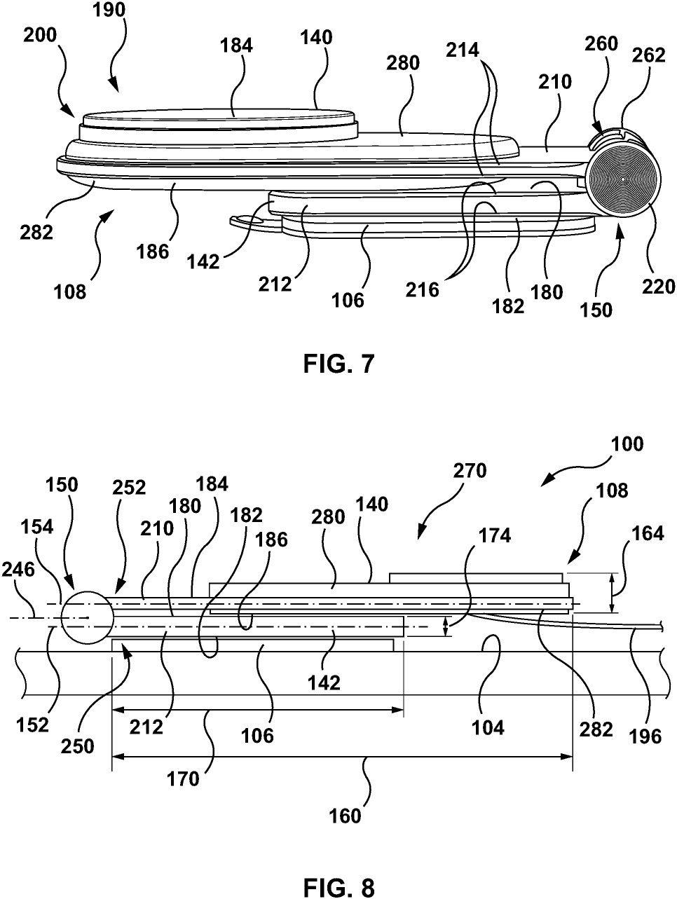

Referring now to FIGS. 4 to 8, the foldable frame 108 includes an upper panel 140 and a base panel 142. The upper panel 140 and the base panel 142 are connected by a hinge 150.

The upper panel has a maximum length 160, a maximum width 162 (FIG. 10), and a maximum depth 164. The maximum depth 164 is less than about 50%, less than about 30%, less than about 25%, or less than about 10% of the lesser of the maximum width 160 and the maximum length 162. The base panel has a maximum length 170, a maximum width 172 (FIG. 10), and a maximum depth 174. The maximum depth 174 is less than about 50%, less than about 30%, less than about 25%, or less than about 10% of the lesser of the maximum width 170 and the maximum length 172.

As exemplified, the upper panel 140 and the base panel 142 are each generally planar panels. In other words, the upper panel 140 and the base panel 142 are plate-like panels with opposed faces that are generally planar faces. The base panel 142 includes an upper face 180 and an opposed lower face 182 with a consistent depth across generally the entire panel (i.e., a consistent distance between the upper and lower faces 180, 182). As exemplified, the consistent depth is equal to the maximum depth 174 of the base panel 142. The upper panel 140 also includes an upper face 184 and a lower face 186. The upper and lower faces 184, 186 of the upper panel are each formed of a set of generally planar surfaces with stepped transitions between planar surfaces.

The upper panel 140 includes a wireless charger 190. The wireless charger 190 is configured to wirelessly charge a mobile device received against the upper surface 184 of the upper panel 140 (e.g., as in FIGS. 1 and 2). In some examples, the wireless charger 120 is includes an induction coil mounted within the upper panel 140 for inductive charging. The wireless charger 190 also includes a cord 196 coupled to the induction coil to supply power to the induction coil. The cord 196 extends out from the lower surface 186 of the upper panel 140.

The upper panel 140 also includes a magnetic mounting system 200. The magnetic mounting system 200 is included in the upper panel adjacent the wireless charger 190 to hold the mobile device 102 against the upper surface 184 of the upper panel 140. The magnetic mounting system 200 includes magnets and/or ferromagnetic material to attract magnets and/or ferromagnetic material in the mobile device 102.

The upper panel 140 includes a metal plate 210. The metal plate 210 is an aluminum plate. The base panel 142 includes a metal plate 212. The plate 212 is an aluminum plate. The exemplified lateral edges 214 of the upper panel 140 are beveled and the exemplified lateral edges 216 of the base panel 142 are beveled.

The base panel 142 extends generally in a first plane 152 and the upper panel 140 extends generally in a second plane 154 (FIG. 8). The frame 108 is configured to be folded flat. The frame 108 is configured to be folded with the upper panel 140 against (i.e., alongside; e.g., touching or within about 0.5 cm, about 0.25 cm, or about 0.1 cm) and overlying the base panel 142 and the first and second planes generally parallel (FIG. 8).

The hinge 150 includes a first cylindrical portion 220 having a first longitudinal axis 222, and the hinge 150 includes a second cylindrical portion 230 having a second longitudinal axis 232. The first and second cylindrical portions 220, 230 are arranged with the first and second longitudinal axes 232, 242 each coaxial with an axis of rotation 244 of the hinge 150. The first and second cylindrical portions 220, 230 are rotatable relative one another about the axis of rotation 244.

When the frame 108 is folded with the upper panel 140 against and overlying the base panel 142, as in, e.g., FIG. 8, the axis of rotation 244 is in an axis plane 246 that is generally parallel to the first and second planes 152, 154. When the frame 108 is folded with the upper panel 140 against and overlying the base panel 142, an inner edge 250 of the base panel 142 is joined to the first cylindrical portion 220 and an inner edge 252 of the upper panel 140 is joined to the second cylindrical portion 230. The inner edge 250 is joined to the first cylindrical portion 220 below the axis plane 246, and the inner edge 252 of the upper panel 140 is joined to the second cylindrical portion 230 above the axis plane 246 and/or above the inner edge 250 of the base panel 140.

When the frame 108 is folded with the upper panel 140 against and overlying the base panel 142, the first plane 152 generally bisects the first panel 140 and/or the plane 210, and the second plane 154 generally bisects the base panel 142 and/or the plane 212, and the first and second planes 152, 154 sandwich the axis plane 246.

As exemplified, the hinge 150 includes a track 260 to limit the rotational movement of the first cylindrical portion 220 relative to the second cylindrical portion 230. The exemplified track 260 includes a recessed portion of the first cylindrical portion 220 with a seat 262 on the first cylindrical portion 220 against which the upper surface 184 of the upper panel 140 abuts when the upper panel 140 reaches the top of the rotational extent.

The length 160 of the upper panel 140 is greater than the length 170 of the base panel 142 such that an upper portion 270 of the upper panel 140 extends beyond the base panel 142 when the upper panel 140 is folded flat against and overlying the base panel 142. The cord 196 extends out from the upper portion 270 of the upper panel 140.

The exemplary upper panel 140 includes a protective pad 280 on the upper surface 184 around the wireless charger 190. The protective pad 280 may prevent damage (e.g., scratching) to the mobile device 102 when the mobile device 102 is handled roughly in the vicinity of the wireless charger 190.

The upper panel 140 also includes a protective pad 282 on the lower surface 186 opposite the wireless charger 190. The protective pad 282 extends over the upper portion 270 of the upper panel 140 and the cord 196 extends out from the protective pad 282 on the lower surface 186 of the upper panel 140. The protective pad 282 may be part of the same body of material as the protective pad 280 (i.e., extending through an aperture in the metal plate 210).

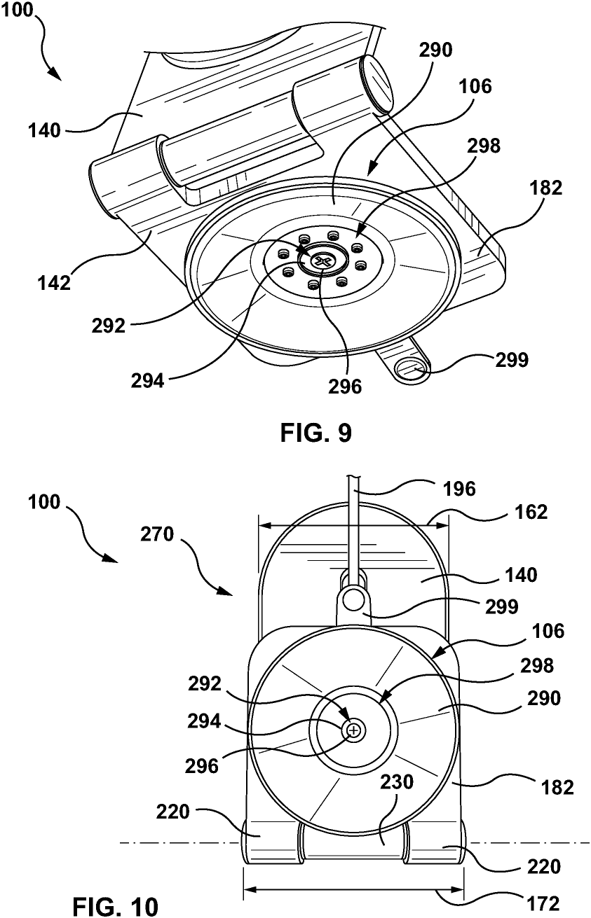

Referring now to FIGS. 9 and 10, the suction cup 106 is secured to a lower surface 182 of the base panel 140. The suction cup 106 is directed away from the lower surface 182 of the base panel 140 to releasably mount the wireless charging stand 100 to an environmental surface 104. The suction cup 106 provides stability on environmental surfaces. The suction cup 106 inhibits lateral movement as well as lifting movement. The suction cup also allows for a simple construction with easy foldability.

As exemplified, the suction cup 106 includes a circular cup 290 with a diameter between about 5 cm and about 10 cm. In some embodiments, the diameter of the circular cup 290 is between about 6 cm and about 7 cm. The exemplary circular cup 290 is a transparent cup. The cup 290 may be formed of a plastic material.

The exemplified suction cup 106 is secured to the base panel 140 via a threaded fastener 292 and a washer 294. The washer 294 and a head 296 of the threaded fastener 292 are positioned in an inner cup region 298 of the suction cup 106. The suction cup 106 includes a tag 299 for use in deforming the cup 290 to release the suction cup 106.

In use, the wireless charging stand 100 can be folded, with the upper panel 140 against the base panel 142. For example, the stand 100 may be folded with the protective pad 282 touching the base panel 142 or spaced from the base panel 142 by less than about 0.5 cm, about 0.25 cm, or about 0.1 cm. The stand 100 can be folded such that the suction cup 106 and the wireless charger 190 each face out from the foldable frame 108. The stand 100 may then be inserted, in its folded configuration, into a pocket of an item of clothing (e.g., a front pocket of a pair of jeans or a pouch of a hoody).

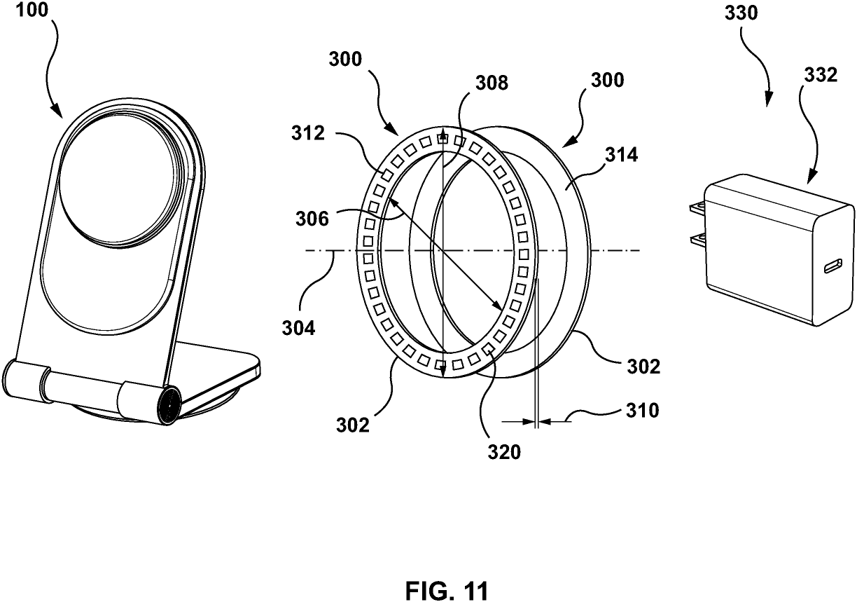

Referring to FIG. 11, illustrated is an example of a mounting apparatus 300 for retrofitting a mobile device. The mounting apparatus 300 includes a continuous metal ring 302. The metal ring 302 is formed of a ferromagnetic metal. The ring 302 has a longitudinal axis 304, a circular inner diameter 306 and a circular outer diameter 308. The ring 302 has a generally constant depth 310 between a rear face 312 and a front face 314. The mounting apparatus 300 also includes a layer of adhesive 320 applied to the rear face 312. In use, the mounting apparatus 300 may be secured to the main body and/or case of the mobile device (e.g., the adhesive 320 holding the mounting apparatus 300 to the mobile device). The mounting apparatus 300 may allow a mobile device that does not have a built-in magnetic mounting system to be retrofitted for use with, e.g., the stand 100. In some embodiments, the mounting apparatus 300 includes permanent magnets instead of, or in addition to, the metal ring 302.

Referring to FIG. 11, the stand 100 may be provided as part of a kit 330. The kit 330 also includes the mounting apparatus 300. The mounting apparatus 300 may be used to retrofit a mobile device (e.g., a main body and/or a case of the mobile device) for use with the magnetic mounting system 190 of the stand 100. In some embodiments, the kit includes the stand 100, two mounting apparatus 300, and an adapter 332. For example, the adapter 332 may be a 20 Watt adapter to adapt a USB-C connector on the cord 196 for use with a residential wall outlet.

1. A wireless charging stand for a mobile device, comprising:
a. a foldable frame having a top end and a bottom end, the foldable frame including a base panel extending generally in a first plane and an upper panel extending generally in a second plane, the base panel and the upper panel connected by a hinge such that the base panel and the upper panel can be folded with the upper panel against and overlying the base panel and the first and second planes generally parallel;
b. a wireless charger included in the upper panel and arranged facing an upper surface of the upper panel to charge the mobile device when the mobile device is received against the upper surface of the upper panel;
c. a magnetic mounting system included in the upper panel adjacent the wireless charger to hold the mobile device against the upper surface of the upper panel; and
d. a suction cup secured to a lower surface of the base panel and directed away from the lower surface of the base panel to releasably mount the wireless charging stand to an environmental surface.

2. The wireless charging stand of claim 1, wherein the upper panel and the base panel are each generally planar panels, and the foldable frame folds flat with the upper panel against and overlying the base panel.

3. The wireless charging stand of claim 1, wherein the upper panel and the base panel each have a maximum length, a maximum width, and a maximum depth, and for each of the upper and base panels the maximum depth is less than about 25% of the lesser of the maximum width and the maximum length.

4. The wireless charging stand of claim 3, wherein the base panel has a consistent depth across generally the entire panel, the consistent depth equal to the maximum depth of the base panel.

5. The wireless charging stand of claim 1, wherein the upper panel and the base panel each include a metal plate.

6. The wireless charging stand of claim 1, wherein the upper panel and the base panel each include an aluminum plate.

7. The wireless charging stand of claim 1, wherein the suction cup includes a circular cup with a diameter between about 5 cm and about 10 cm.

8. The wireless charging stand of claim 7, wherein the diameter of the circular cup is between about 6 cm and about 7 cm.

9. The wireless charging stand of claim 7, wherein the circular cup is a transparent plastic cup.

10. The wireless charging stand of claim 1, wherein the suction cup is secured to the base panel via a threaded fastener and a washer, with the washer and a head of the threaded fastener positioned in an inner cup region of the suction cup.

11. The wireless charging stand of claim 1, wherein the length of the upper panel is greater than the length of the base panel such that an upper portion of the upper panel extends beyond the base panel when the upper panel is folded flat against and overlying the base panel, wherein the wireless charger includes a cord to supply power to the wireless charger, and wherein the cord extends out from a lower surface of the upper panel and the upper portion of the upper panel.

12. The wireless charging stand of claim 1, wherein the hinge includes a first cylindrical portion having a first longitudinal axis, and the hinge includes a second cylindrical portion having a second longitudinal axis, and wherein the first and second cylindrical portions are arranged with the first and second longitudinal axes each coaxial with an axis of rotation of the hinge, and the first and second cylindrical portions are rotatable relative one another about the axis of rotation.

13. The wireless charging stand of claim 12, wherein, when the frame is folded with the upper panel against and overlying the base panel, the axis of rotation is in an axis plane that is generally parallel to the first and second planes, and an inner edge of the base panel is joined to the first cylindrical portion below the axis plane, and an inner edge of the upper panel is joined to the second cylindrical portion above the axis plane and above the inner edge of the base panel.

14. The wireless charging stand of claim 12, wherein the hinge includes a track to limit the rotational movement of the first cylindrical portion relative to the second cylindrical portion.

15. The wireless charging stand of claim 1, wherein lateral edges of the upper panel are beveled and lateral edges of the base panel are beveled.

16. The wireless charging stand of claim 1, wherein the upper panel includes a protective pad on the upper surface around the wireless charger.

17. The wireless charging stand of claim 11, wherein the upper panel includes a protective pad on a lower surface opposite the wireless charger and extending over the upper portion of the upper panel and the cord extends out from the protective pad on the lower surface of the upper panel.

18. A method of using the wireless charging stand of claim 1, comprising:
a. folding the wireless charging stand with the upper panel against the base panel, such that the suction cup and the wireless charger each face out from the foldable frame; and
b. inserting the folded wireless charging stand into a pocket of an item of clothing.

19. A mounting apparatus for retrofitting a mobile device or a mobile device case, comprising:
a. a continuous metal ring having a longitudinal axis, a circular inner diameter and a circular outer diameter and a generally constant depth between a rear face and a front face; and
b. a layer of adhesive applied to the rear face.

20. A magnetic adherence retrofit kit, comprising:
a. the wireless charging stand of claim 1; and
b. a mounting apparatus for retrofitting a mobile device or a mobile device case, comprising:
i. a continuous metal ring having a longitudinal axis, a circular inner diameter and a circular outer diameter and a generally constant depth between a rear face and a front face; and
ii. a layer of adhesive applied to the rear face.
